(19) United States
(12) Patent Application Publication
(10) Pub. No.: US 2014/0151354 A1
(43) Pub. Date: Jun. 5, 2014

(54) ELECTRICAL HEATER FOR VEHICLE WINDSHIELDS AND WINDOWS

(71) Applicant: Richard Egon Schauble, Calgary (CA)

(72) Inventor: Richard Egon Schauble, Calgary (CA)

(21) Appl. No.: 13/652,102

(22) Filed: Oct. 15, 2012

Related U.S. Application Data
(63) Continuation-in-part of application No. 12/662,448, filed on Apr. 19, 2010.

(51) Int. Cl. B60S 1/02; B60S 1/54

(52) U.S. Cl. CPC B60S 1/026; B60S 1/54
USPC 219/203; 454/127; 454/159

(57) ABSTRACT

An electrical heater for vehicle windshields and windows includes a heating chamber having heat reflective interior walls and at least one electrically driven heater element so as to produce heat from the element when energized, wherein the heater circuit wiring is adapted to only be electrically connected to a conventional DC electrical system of a vehicle, and wherein the heating chamber is adapted to be mounted under the windshield vents of the vehicle to thereby direct airflow flowing over the heater elements as forced by the vehicle's heater core fan through the vehicle ducting and out from the vehicle's windshield vents.

### CROSS REFERENCE TO RELATED APPLICATION

This application is a Continuation-in-Part from application Ser. No. 12/662,488 filed Apr. 20, 2010 entitled Electrical Heater For Vehicle Windshields and Windows.

### FIELD OF THE INVENTION

This invention relates to the field of heaters used in vehicles for producing warm air which may be directed onto windshields and windows of the vehicle, and in particular to a fanless electrical heater which co-operates with the conventional coolant-based forced air heaters provided in conventional vehicles which direct air which is heated by the vehicle's heater core through ducting so as to be directed onto the windshield and side window glass in the interior of the passenger compartment of the vehicle.

### BACKGROUND OF THE INVENTION

In the prior art applicant is aware of U.S. Pat. No. 2,827,540 which issued Mar. 18, 1958, to Underwood for an Auxiliary Electrical Heating System for Motor

Vehicles. Underwood discloses an auxiliary heating system which operates in conjunction with a motor vehicle's then conventional heating system to provide instantaneous heat during the period of time usually required for the conventional heating system to become effective, and in particular the time for the vehicle engine to heat water for the heater. The auxiliary heating system is disabled by a thermo-responsive element breaking the electrical circuit when the vehicles hot water heating system becomes operative. The heating element is taught as being disposed in front and in the path of air from, the conventional blower or fan of the conventional heating system. The arrangement of the element according to one aspect of the present invention is neither taught nor suggested. Further, it is neither taught nor suggested that in extreme winter conditions it is sometimes advantageous to simultaneously operate the electric heater along with the conventional vehicle heating system.

In the prior art, applicant is also aware of U.S. Pat. No. 3,469,073 which issued Sep. 23, 1969 to Zechin for an Electrical System. Zechin discloses an auxiliary electrical heating system which is operative during the transient warm-up, during which an engine's coolant temperature is warmed once the engine is started. Zechin teaches that during the transient warm-up period an alternator is made to produce a higher voltage output than during its normal operation thus providing much greater heating capacity from the auxiliary resistance heater, the direct current (“DC”) load of the vehicle being provided by the vehicles battery during the transient warm-up period.

As discussed by Zechin, in conventional automobiles having conventional hot water heating systems, low ambient temperature conditions cause the vehicles engine coolant to also have the same temperature upon vehicle start-up thereby causing a substantial delay following the engines start-up before the engine coolant fluid temperature increases sufficiently to produce a comfortable output temperature from the vehicles conventional forced air ducted passenger compartment heating system. Zechin thus provides as an object the provision of an auxiliary electrical heating system operable during a transient warm-up period of the primary heater system to produce a high BTU input into the passenger compartment of the vehicle and to provide a generator control system operable to produce a plurality of voltage outputs, one of which voltage outputs serves to energize the electrical resistance element of the auxiliary heater to improve the automobile heating and defrosting system. Zechin teaches including a circuit for supplying one of the voltage outputs as a regulated source to a DC load circuit and for supplying the other of the outputs to the electrical resistance element of the auxiliary heater without affecting the DC load circuit.

As also disclosed by Zechin, the electrical heating units may be arranged serially within the inlet duct work to the passenger compartment to simplify installation and ducting of the heater assembly. Zechin however continues that one problem with auxiliary electrical heating arrangements is that the electrical power output from present-day automobile power systems is typically limited to a regulated voltage usually in the range of 12 volts. As stated by Zechin, such a limited output voltage would require a very high current to supply an adequate electrically produced BTU input for warming the passenger compartment to a comfortable point during the transient warm-up period. Zechin thus provides the electrical resistance heater in association with a generator system which includes means for producing a BTU output at higher voltage from the electrical heater adequate to comfortably warm the vehicle passenger compartment during the transient warm-up, and for supplying a regulated limited voltage during other periods.

What applicant has determined, and which it is an object of the present invention to provide, is that if one reduces the expectation of Zechin from his stated objective of warming the passenger compartment of the vehicle to instead providing only a targeted warm air defrosting of the vehicle windshield, by using efficient electrical resistance heaters, or efficient infrared radiation heaters, and with the strategic placement of the heater elements relative to the existing forced air heating system duct work in the vehicle, that effective defrosting may be obtained without the requirement of Zechin of producing a higher voltage than is normally available from a conventional vehicle alternator.

In the prior art the applicant is also aware of U.S. Pat. No. 4,963,716 which issued Oct. 16, 1990 to Van Den Elst et al, for a vehicular air heater using PTC heater tablets associated with funnel heat exchanges. Van Den Elst et al describe an air heater mounted in a ventilation slot beneath a vehicle window wherein ceramic heater tablets are positioned between two metal strips and fastened thereto in thermally and electrically conductive relation. Heat exchangers which include sheet metal fins having baffles are secured in electrically and thermally conductive relation to the opposite sides of the strips so that the baffles introduce turbulence into the air flowing over the strips. Other metal strips having electrical terminals are thermally and electrically connected to the fins opposite to the strips for energizing the heater tablets. The tablets are spaced to define flow passages therebetween so that the air flowing through the ventilation slot passes over the heating exchangers, plates and tablets will rapidly withdrawing heat from the tablets. There is no teaching nor suggestion to use heat reflectors.

### SUMMARY OF THE INVENTION

The present invention mounts into a vehicle having a conventional DC electrical system, where the vehicle has a fan cooperating with a heater core of the vehicle engine, and forced-air ducting for providing heat from the heater core driven by the fan through the ducting to the passenger compartment of the vehicle via at least one under-windshield vent in the vehicle dashboard directed to the underside of the vehicle windshield.

In summary, the electrical heater according to one aspect of the present invention for defrosting vehicle windshields and windows may be characterized as including at least one electrically driven heater element within a heating chamber, and heater circuit wiring electrically connected to the elements for electrically driving the elements to produce heat from the elements when so driven. The heater circuit wiring is adapted to only be electrically connected to the conventional DC electrical system of the vehicle. The heater elements are also adapted in the windshield dedicated ducting branching off the primary general purpose ducting from the blower, for example the elements may be adapted to only be mounted to or in the under-windshield vents of the vehicle to thereby direct airflow flowing over the heater elements, as forced by the vehicle's fan through the vehicle's ducting and out from the vehicle's under-windshield vents only onto the underside of the windshield, or to the windshield and side window clearing vents also.

Advantageously at least one hazardous condition detector cooperates with the heater circuit wiring to shut-off the energizing of the heater element upon detection of a hazardous condition by the detector. For example, the hazardous condition detector may be adapted to detect hazards including overheating of the element, overheating of the vents or ducting, non-operative fan, non-operative vehicle engine.

Preferably the heating chamber is mounted into at least one of the under-windshield vents so as to bring the chamber and its heater element into closest proximity to the windshield while still cooperating with the forced-air airflow travelling through and from the dashboard upper vent.

The heater elements may advantageously include a quartz carbon-fibre elements, or may include an infrared radiator elements or may include a ceramic or suitable and efficient electrically driven elements.

In the method according to a further aspect of the present invention for installing the electrical heater described above, the following steps may be employed:

a) providing an electrically driven heater elements mounted within a heating chamber;
b) providing heater circuit wiring and electrically connecting the wiring to the element to electrically drive the elements to produce heat from the elements within the chamber,
c) mounting the heating chamber only to the under-windshield vents of the vehicle to thereby direct airflow flowing over the heater elements as forced by the fan through the ducting and out from the under-windshield vents onto the underside of the windshield, or also by side vents onto the side windows.

### BRIEF DESCRIPTION OF THE DRAWINGS

FIG. 1 is a diagrammatic representation of the electrical heater according to the present invention installed in the under-windshield vents of a vehicle forced-air ducted heating system.

FIG. 2 is a simplified electrical schematic diagram of one embodiment of the electrical system controlling the electrical heater of the present invention.

FIG. 3 is, in top view, a partially cut away view of the top of a heating chamber according to one aspect of the present invention.

FIG. 4 is, front elevation view, the heating chamber of FIG. 3 containing three horizontally disposed parallel spaced apart heating elements.

FIG. 5 is, in side elevation view, the heating chamber of FIG. 4.

FIG. 6 is a sectional view along line 6-6 in FIG. 6.

FIG. 7 is, in top view, an alternative embodiment of a heating chamber according to one aspect of the present invention.

FIG. 8 is, in top view, a further alternative embodiment of the heating chamber according to one aspect of the present invention.

FIG. 9 is a diagrammatic representation of the electrical heating system for windshields according to one embodiment of the present invention illustrating a single heating chamber installed in a single windshield vent.

FIG. 10 is a diagrammatic representation of a windshield heating system according to one aspect of the present invention illustrating the use of a two heating chambers in dual windshield vents.

### DETAILED DESCRIPTION OF EMBODIMENTS OF THE INVENTION

In a first embodiment of the present invention, which is not intended to be limiting, an electrical heating system according to the present invention may be installed on new vehicles at the time of their manufacturing by installing a heating chamber containing electrically driven heater elements 10 as close as possible to the ducting vent where it directs the air from the duct up onto the windshield. Heater elements 10 may be for example high efficiency electrical resistance heating elements, such as for example carbon fibre heating elements from DC Thermal LLC of Crocket, Tex., U.S.A., or electrically driven radiation heating elements such as for an infrared radiation heater, for example quartz based.

In this embodiment each electrically driven heating element 10 is directly wired into the vehicle electrical system subject to some or all of the switching arrangements discussed below, The vehicles existing forced air fan is used to blow air through the vehicles heating system duet work to thereby force initially cold air to flow over the electrically driven heater elements 10 to thereby provide immediate hot air directly onto the windshield, and in some vehicle designs having side ducting outlets, also directly onto the vehicle's side windows.

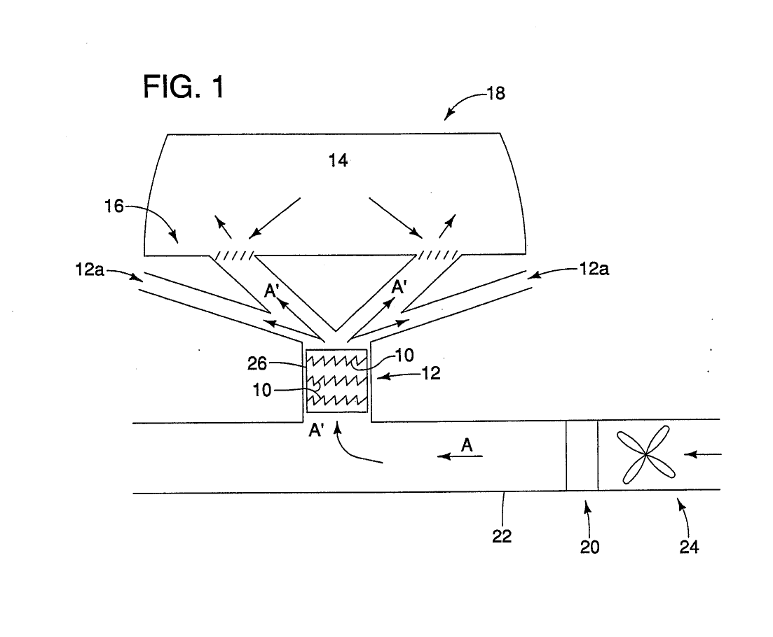

As seen in FIG. 1, electrically driven heater elements 10 are mounted in heating chamber 26 in the vehicle under-dash ducting 12, that is, in the ducting dedicated to feeding the windshield vents and so as to direct air moving in direction and not in the general or primary ducting 22 system. For example chamber 26 and elements 10 may be mounted close to or directly under the dashboard vents 14 in the upper surface of dashboard 16 so long as within dedicated windshield ducts 12. Vents 14 are positioned by the manufacturer directly under the windshield 18. The vehicle engine coolant heater core 20 is mounted upstream relative to airflow direction A within the primary ducting 22 and typically immediately downstream of the vehicle's forced air fan 24. Air moving in direction A flows to the passenger compartment ducts (to the left in FIG. 1)

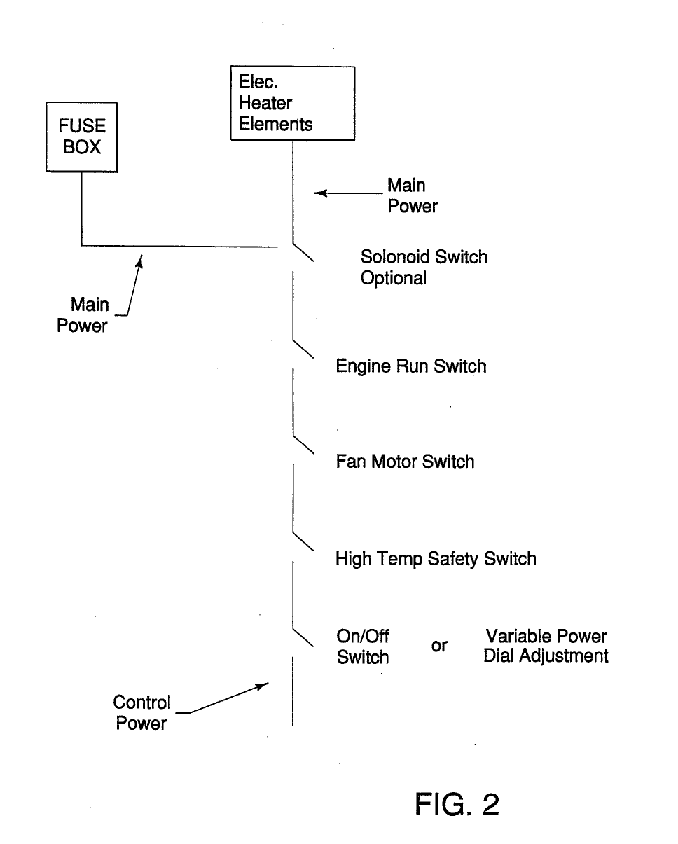

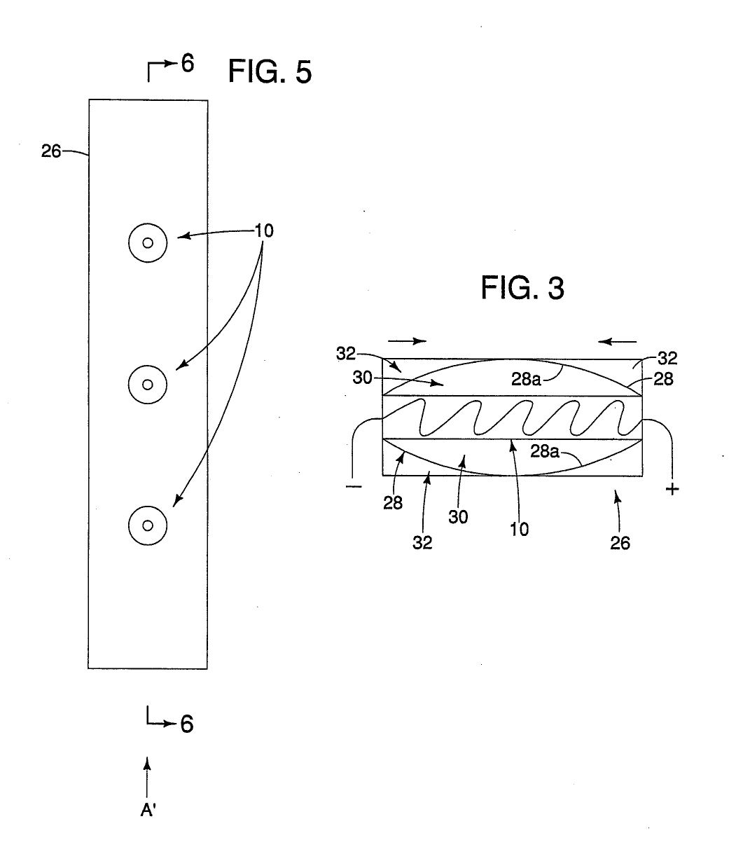

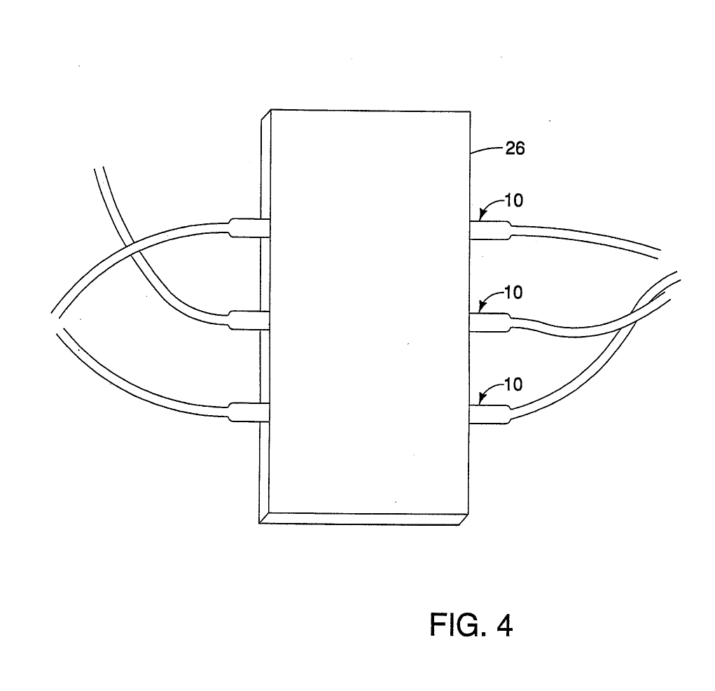

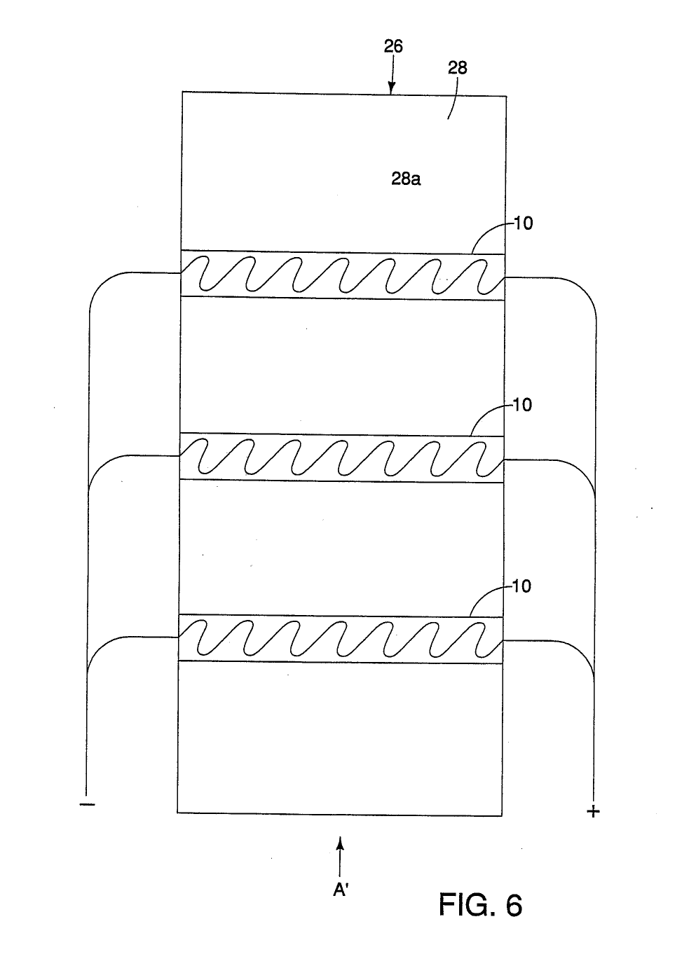

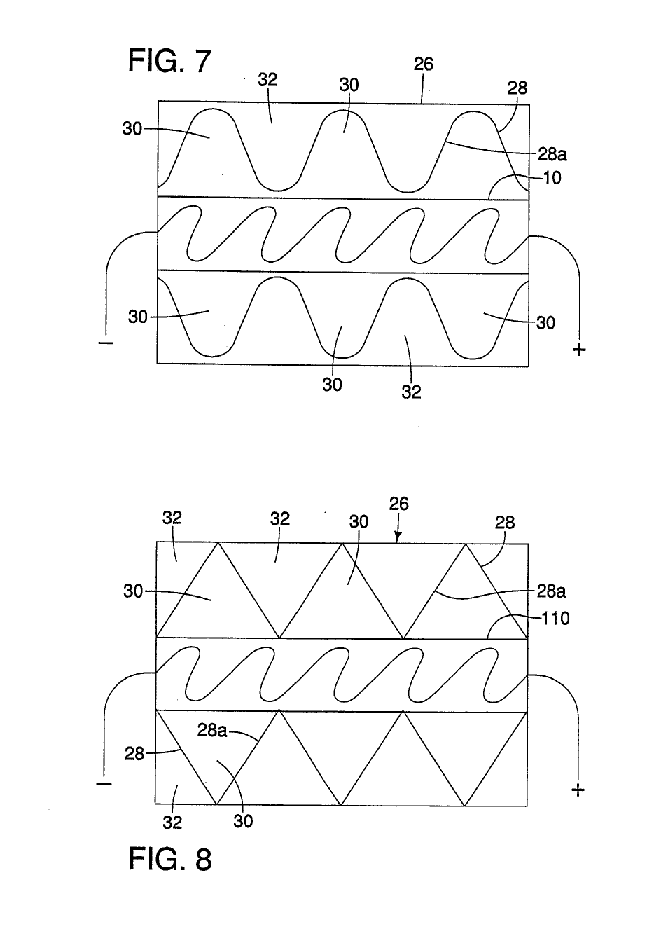

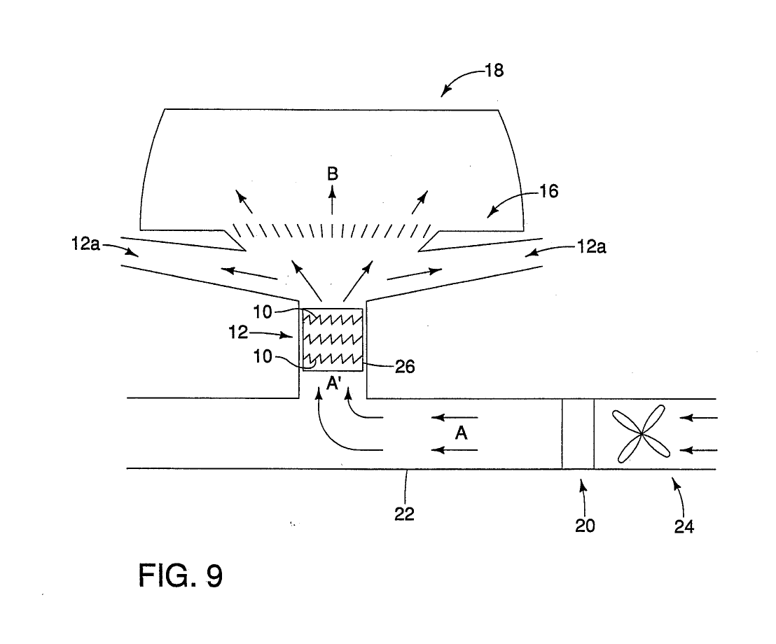

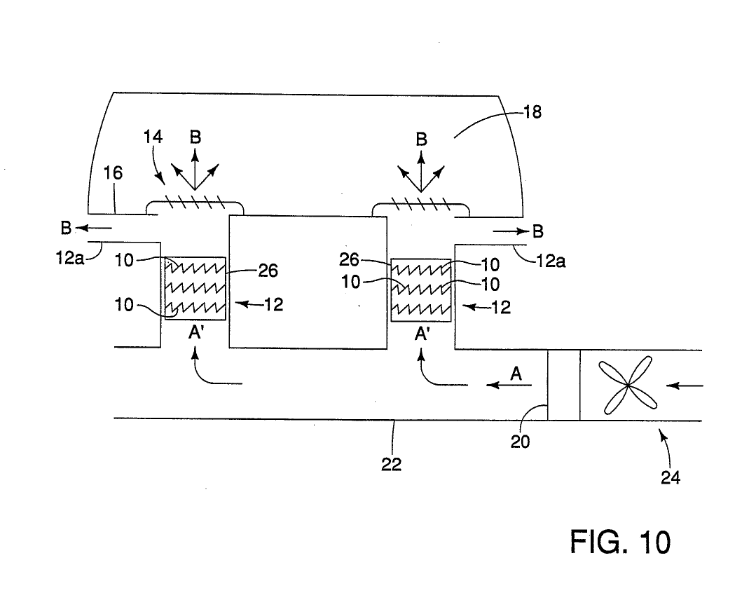

Preferably in this embodiment and as seen in FIG. 2 the electrically driven heater elements 10 may not be energized without the vehicle's engine running so as to prevent the vehicles battery from being discharged. Consequently an automatic shut-off for driven heater elements 10 may be provided and also an on/off switch may be provided which may be manually controlled or for example automatically operate in conjunction with a temperature sensor sensing the temperature of both the ambient air and the engines coolant liquid. Further switching would also only allow the energizing of driven heater elements 10 when the vehicle's forced air fan is running so as to prevent overheating of the heater elements. In any event, advantageously a high temperature cut-off safety switch is mounted in proximity to heater elements 10 so as to open, thereby cutting off electricity to heater elements 10, if a temperature is detected which exceeds a preset safe temperature, for example that dictated by the material from which the automobile ducting is constructed.

As would be known to one skilled in art, chamber 26 may advantageously be provided with insulation to avoid damage to the upper surface to dashboard 16, for example in the instance where a user leaves the heater elements energized while the forced air fan 24 is turned off. Again advantageously, a temperature detecting safety switch would be mounted in chamber 26 so as to shut off the heater elements if the detected temperature exceeded a preset safety temperature. Further advantageously, a count down timer may be provided in a preferred embodiment that would shut off heater elements 10 automatically, for example after a 15 or 20 minute period of time, so as to provide both safety and so as to avoid draining the vehicle's battery if the heater elements were left turned on when the engine was shut off.

As will be noted, in all embodiments, in order to avoid complex modifications to the vehicle electrical system as would be required if the teaching in the prior art was followed, in the present invention the conventionally available amperage is used in an optimized fashion by the placing of electrically driven high efficiency heater elements 10 which are mounted in chamber 26 as closely as practically possible in proximity to the automobile windshield so as to take advantage of the already existing forced air fan in the vehicles ducted forced air heating system and so as to negate heat loss to the initially cold side walls of the vehicles under dash ducting once the air flow has been heated by flowing over the electrically driven heating elements.

The present invention also avoids the problem in the prior art teaching where, in the event of a very cold weather engine start where the vehicle battery is barely capable of sufficient cranking amperage, transferring all of the DC load including that of the fan to the already overtaxed battery during the transient warm-up of the engine so that the alternator may exclusively provide increased voltage to an electric passenger compartment heater, may merely cause the battery to fail, and thus the engine to stop thereby shutting off the fan and alternator along with it. In such instances the passenger compartment heating circuit would may be by-passed or switched off to allow the vehicle engine to warm-up and the passenger compartment to only thereafter be warmed conventionally. The present invention avoids this draw back of the prior art by merely operating on the conventionally available in-vehicle voltage and amperage. In very cold weather starts, the vehicle engine is started in the usual manner, for example with the fan and other electrically loading accessories shut-off. Once the engine starts then the fan etcetera may be immediately turned on along with the electrical windshield defroster according to the present invention, thereby allowing the vehicle to be quickly operated without prolonged idling, scraping of the windshield, etcetera. The reduction in vehicle idling saves the driver time, and improves fuel economy (idling gets zero miles per gallon), and reduces overall vehicle emissions per trip.

Within heating chamber 26, which is mounted within duct 12, heating elements 10 are sandwiched between, and spaced from, an opposed facing pair of heat reflectors 28. The interior facing surfaces 28a are heat reflective, for example by the use of reflective coating or material, or by the use of a mirror or mirror-like surface finish.

In one embodiment reflectors 28 are strips of thin metal arranged vertically. For example the metal strips may be 0.008 to 0.010 inches in thickness, and arcuately curved to reflect heat radiated from elements 10 back into the airflow passing in direction A′ through the air gap 30 between the opposed facing surfaces 28a. The vertical orientation of the metal strips, meaning that the strips are oriented parallel with the walls of ducting 12, is intended to minimize interference with the airflow. Similarly, advantageously the surfaces 28a are smooth, again to minimize interference with the airflow to thereby reduce airflow pressure loss and maximize the windshield clearing effect of the airflow. The airflow also flows freely in airflow passages 32 between the rear surfaces of reflectors 28 and the interior walls of chamber 26.

The arcuate curvature of heat reflectors 28 may include, as illustrated, a concave curvature, sinusoidal curvature, zig-zag “curvature”, or may include other heat reflective curvatures or geometries so long as heat radiation is directly reflected back towards heating elements 10.

Heating chamber 26 is positioned within duct 12 a sufficient distance from windshield 18 so that heated airflow At does not damage the material of dashboard 16, but otherwise is positioned as closely as possible to windshield 18 to maximize the heated clearing effect of the airflow.

Heating chamber 26 may also have reflective surfaces in the manner of reflective surfaces 28a on the chamber walls so as to further reflect heating radiation from elements 10 which is re-radiated through reflectors 28 or which by-passes reflectors 28, so as to reflect heat back into airflow passages 32 which bypass air gap 30. Advantageously chamber 26 will have sufficient length, for example four inches or such other length as allowed for within duct 12, to provide a dwell time of the airflow within chamber 26 within which dwell time the airflow may be sufficiently warmed, without the use of pressure and airflow volume reducing baffles, or ribs, or fins such as found in the prior art which increase the fan and heating requirements and consequent burden on the vehicle's electrical system. The necessary dwell time is governed by factors including ambient air temperatures, airflow rate available electrical power to elements 10, the size of ducts 12, etcetera, as would be known to one skilled in the art.

In a preferred embodiment, an air temperature sensor may be provided so as to work in conjunction with either the power supply to fan 24 or to heating elements 10 by lowering or increasing the power supply to the heating elements 10. For a particular ambient air temperature, for example the air temperature sensed within the cabin of the vehicle, a processor (not shown) determines the optimal available power supply for heating elements 10 or to the fan 24 so as to provide for safe air discharge temperatures exiting from ducts 12 and through the vents 14 in dashboard 16 underneath windshield 18. Preferably the direct current voltage may be automatically regulated by the processor so as to control fan 24 and/or heating elements 10, to provide just one example of how optimizing control may be performed.

In a preferred embodiment, heating chamber 26 is of modular design so that a manufacturer may modularly assemble the heating chamber 26, the heat reflectors 28, and the heating elements 10 to accommodate different ducting and different voltage systems, to provide just two examples. Thus as many heating elements 10 may be installed as will be supported by the power supply of the particular vehicle. The greater the available power supply and corresponding heating elements 10, when used in conjunction with the heat reflectors as described herein, the lower (for example approximately minus 30-50° C.) the temperature limits at which the windshield defrosting using the present system will effectively operate to clear a frosted windshield, since the elements will always put out a certain number of BTU regardless of outside temperatures. The heater is only restricted by power supply and element size. For example a 12000 BTU heater will put out 12000 BTUs regardless of outside temperature so a driver will have the benefit of getting 12000 more BTUs at any given outside temperature. For example, a single heating element 10 having a typical 100 watt power assumption at 8.5 amps equates approximately to 2000 BTU in heat. Extrapolating from that example, which is not intended to be limiting, two such heating elements 10 using then 17 amps of current would generate approximately 4000 BTU, and three heating elements 10, at 25.5 amps would generate approximately 6000 BTU in a typical 12 volt electrical system conventionally found in gasoline engine powered vehicles. Vehicles such as some conventional diesel powered vehicles which have a 24 volt electrical system will work more efficiently, for example, when employing three 100 watt heating elements 10, at 12.75 amps generating approximately 6000 BTU, or for example, three elements 10 having a 200 watt capacity and using 25.5 amps, would generate approximately 12000 BTU. Thus it would be evident that a system according to the present invention may be adapted to many sizes and types of vehicles and power supplies so as to reduce the required warm-up time for the vehicle and to allow for quicker safe driving thereby, and thereby also reducing emissions due to the quicker way in-up time of the vehicle once it is moving.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An electrical heater for vehicle windshields and windows in a vehicle having a conventional DC electrical system, a fan cooperating with a heater core of the vehicle engine, and forced-air ducting for providing heat from the heater core driven by the fan through the ducting to the passenger compartment of the vehicle via at least one under-windshield vent in the vehicle dashboard directed to the underside of the vehicle windshield, the heater comprising:
a) a hollow heating chamber having opposite open ends and adapted for mounting and mountable into the ducting beneath the under-windshield vent so as to dispose said open ends in an airflow through the ducting for fluid communication of the airflow through said hollow heating chamber,
b) electrically driven at least one heater element mounted laterally across said heating chamber so as to be laterally across the airflow through the heating chamber;
c) heater circuit wiring electrically connected to said at least one heater element for electrically driving said at least one heater element to produce heat from said element when so driven,
d) at least one pair of heat reflectors mounted in opposed facing relation laterally across said heating chamber so as to dispose said at least one heater element between said opposed facing heat reflectors,
wherein said heater circuit wiring is adapted to only be electrically connected to the conventional DC electrical system of the vehicle,
and wherein said heater element is adapted to only be mounted adjacent the under-windshield vents of the vehicle to thereby direct airflow flowing over said at least one heater element as forced by the fan through the ducting and out from the under-windshield vents only onto the underside of the windshield,
and wherein said at least one heater element is not electrically connected to said at least one pair of heat reflectors and are not electrically driven so as to remain passive reflectors,
and wherein each heat reflector of said at least one pair of heat reflectors has a heat reflective surface in said opposed facing relation.

2. The heater of claim I further comprising at least one hazardous condition detector cooperating with said heater circuit wiring to shut-off energizing of said heater element upon detection of a hazardous condition by said detector.

3. The heater of claim 2 wherein said hazardous condition detector is adapted to detect hazards chosen from the group comprising: overheating of said element, overheating of the vents or ducting, non-operative fan, non-operative vehicle engine.

4. The heater of claim I wherein said at least one heater element is an array of substantially parallel elements mounted into said heating chamber.

5. The heater of claim 1 wherein said at least one pair of heat reflectors includes a pair of concave opposed facing reflectors.

6. The heater of claim 1 wherein said at least one pair of heat reflectors includes a pair of substantially sinusoidally arcuate opposed facing reflections.

7. The heater of claim 1 wherein said at least one pair of heat reflectors includes a pair of substantially zig-zag opposed facing reflectors.

8. The heater of claim 1 wherein said heating chamber has walls which include heat reflective inner surfaces on said walls adjacent said at least one pair of heat reflectors.

9. The heater of claim 8 wherein said walls include oppositely disposed walls of said walls of said heating chamber, and wherein a first pair of air passageways are formed between and heated by said at least one heater element and said at least one pair of heat reflectors, and wherein a second pair of air passageways are formed between and heated by said at least one pair of heat reflectors and said oppositely disposed walls of said walls of said heating chamber.
